(19) United States
(12) Patent Application Publication
(10) Pub. No.: US 2022/0116218 A1
(43) Pub. Date: Apr. 14, 2022

(54) SELECTIVE VERIFICATION SYSTEM OF ZERO-KNOWLEDGE PROOFS FOR SCALABILITY OF BLOCKCHAIN AND METHOD THEREOF

(71) Applicant: THE INDUSTRY & ACADEMIC COOPERATION IN CHUNGNAM NATIONAL UNIVERSITY, Daejeon (KR)

(72) Inventors: Jaecheol RYOU, Daejeon (KR); Junhoo PARK, Daejeon (KR); Geunyoung KIM, Daejeon (KR); Hyeokjin KIM, Daejeon (KR)

(21) Appl. No.: 17/261,895

(22) PCT Filed: Aug. 20, 2020
(86) PCT No.: PCT/KR2020/011093

§ 371 Date: Jan. 21, 2021

(30) Foreign Application Priority Data
Nov. 20, 2019 (KR) 10-2019-0149544

(51) Int. Cl. H04L 9/32; H04L 9/08

(52) U.S. Cl. CPC H04L 9/3221; H04L 2209/26; H04L 2209/38; H04L 9/0894

(57) ABSTRACT

Provided are a selective verification system and method of zero-knowledge proofs for scalability of a blockchain, the system including: a proof unit generating a proof as a result of Prove( ) for a fact to be proved, and generating a transaction in the blockchain and storing the proof; a verification unit executing, when a new proof is registered, off-chain Verify( ) for a contract, a vk, and the proof, standing by when a result of execution is a value of true, and after a preset time elapses, determining that the proof is true; and an operation unit executing on-chain Verify( ) in response to a request for verification from the verification unit and imposing a penalty when a result of execution is a value of false.

### TECHNICAL FIELD

The present disclosure relates to a selective verification system and method of zero-knowledge proofs for scalability of a blockchain. More particularly, the present disclosure relates to a technology for preserving user privacy at a small fee through selective verification of zero-knowledge proofs in a blockchain-based verification system.

### BACKGROUND ART

A smart contract of a blockchain assures transparent execution without the need for trust in a distributed environment. Ethereum is one of public blockchains that support a smart contract system executing a program in a blockchain. In Ethereum, a decentralized application (DApp) is able to be developed using a programing language called Solidity.

However, unfortunately, when the DApp of Ethereum is executed, input parameters and results of execution are open to all users. In addition, since information in the blockchain is open to everyone and cannot be deleted, uploading of user information to the blockchain may be a serious problem.

As described above, privacy is not preserved in the blockchain, and thus it is difficult to use the DApp for situations where a blockchain-based application needs to handle or authenticate user information.

In addition, information open in the blockchain shows information of smart contracts as well as transactions between users. In all transactions made on the blockchain, senders, receivers, the amount being sent are wholly open. It is not open who the owner of the address in the blockchain is, but information on the owner of the address is unquestionably open in a process of trading for fiat money through an exchange.

As a method of solving the above-described problem with privacy, zero-knowledge proofs have been widely used in the blockchain, and the users only upload proof values to the blockchain without opening their values. Herein, in the blockchain, an actual value is not known, but using only the proof value, on-chain verification is performed and it is proved that the user has a value.

The zero-knowledge proofs are cryptographic methods in which possession of a value is proved without showing information thereof. In a zero-knowledge proof, the following are involved: a prover that proves that it has a secret value without showing the value; and a verifier that verifies that the prover has the value without using the secret value of the prover.

This may be achieved through multiple interactions between the prover and the verifier. However, it is difficult to have communication several times in the blockchain, so by using non-interactive zero-knowledge proofs having no communication, the prover generates proofs through a secret value of the prover and the verifier verifies that the prover has the secret value through verification of the proofs.

The prover converts a statement, which is desired to be proved, into a mathematical circuit, such as arithmetic circuit, and a Boolean circuit, and then applies a mathematical problem to the circuit, thereby generating a proof that is difficult to calculate without being aware of the secret value. The verifier is able to verify the validity of the proof at verification cost lower than the cost of generating a proof.

In addition, in order to preserve privacy, the prover uses a method in which only a proof value of the prover is uploaded to the blockchain and the proof value is verified in the blockchain, thereby proving possession of a value while hiding personal information of the prover. To use this method, there are implementations such as zk-SNARK, zk-STARK, Bulletproofs, and the like.

Among them, zk-SNARK has fast verification speed. However, a common reference string (CRS) value is received as input in a state of creating a verification contract, so when the value is open, a fake proof may be generated. Therefore, a trusted setup by a trustworthy third-party is required. In comparison, zk-STARK or bulletproofs do not require a trusted setup. However, the size of a proof for verification in zk-STARK is extremely larger than that is zk-SNARK. Bulletproofs has a higher verification cost than zk-SNARK. Regarding VC (verification contract) of bulletproofs or zk-STARK, a verification method of the implementation is implemented in Solidity and an externally generated proof is verified in Ethereum.

However, unfortunately, verification of a proof value in the zero-knowledge proofs is costly and the proof value is heavy. Even zk-SNARK, which has a relatively low verification cost among the zero-knowledge proofs, has an extremely high verification cost compared to the Elliptic Curve Digital Signature Algorithm (ECDSA) verification.

If change takes place to a zero-knowledge proof instead of ECDSA-based signature in Ethereum, the transactions per second (TPS) is greatly reduced, resulting in degradation of scalability.

In addition, in the conventional zero-knowledge proofs, a proof value is not stored in a storage, which costs only the verification. However, in SVZK, a proof value is stored in a storage and verification is performed, so if a user that uploads a wrong proof value, a higher fee is incurred, resulting in poor performance.

In addition, the system may be kept safe by reporting the user that uploads the wrong proof value, but if the report is not made before an epoch passes, the wrong proof value may be confirmed. Therefore, it can be dangerous if a profit that may be gained is greater than a penalty for uploading a wrong proof value. For the above-described reasons, a Dapp using a zero-knowledge proof has not been widely used.

To solve the problems, the present applicant intends to provide a system that preserves privacy at low cost through selective verification of zero-knowledge proofs. According to an embodiment of the present disclosure, a proof value is uploaded to a blockchain, but regarding verification, after off-chain verification is performed by other verifiers, on-chain verification is performed only on a false proof value and on-chain verification is not performed on a proof value that does not need to be verified, thereby achieving scalability.

### DOCUMENT OF RELATED ART

### Patent Document

Korean Patent Application Publication No. 10-2019-0076535 (Jul. 2, 2019)

### DISCLOSURE

### Technical Problem

The present disclosure is directed to providing selective verification of zero-knowledge proofs (SVZK), wherein a proof value of a zero-knowledge proof is stored in a blockchain, on-chain verification is performed only on a proof value for which the verification result is false or a proof that is stored without verification and the verification of it is invalid, thereby reducing the cost of operation and thus improving scalability.

### Technical Solution

According to the present disclosure, there is provided a selective verification system of zero-knowledge proofs for scalability of a blockchain, the system including: a proof unit generating a proof as a result of Prove( ) for a fact to be proved, and generating a transaction in the blockchain and storing a deposit and the proof; a verification unit executing, when a new proof is registered, off-chain Verify( ) for a contract, a vk, and the proof, and determining that the proof is true when a result of execution is a value of true and a preset time elapses; and an operation unit executing on-chain Verify( ) in response to a request for verification from the verification unit.

Preferably, when the result of execution of Verify( ) is a value of false, the verification unit transmits the request for verification of the proof to the operation unit.

In addition, when a result of execution of Verify( ) is a value of false, the operation unit imposes a preset penalty from the deposit of the proof unit.

There is provided a selective verification method, which is based on the above-described system, of zero-knowledge proofs for scalability of a blockchain, the method including: (a) generating, by a proof unit, a proof as a result of Prove( ) for a fact to be proved; (b) generating, by the proof unit, a transaction in the blockchain and storing the proof; (c) executing, by a verification unit when a new proof is registered, off-chain Verify( ) for a contract, a vk, and the proof; and (d) determining that the proof is true by the verification unit when a result of execution of Verify( ) at the step (c) is a value of true and a preset time elapse.

In addition, the method may further include: (e) transmitting, by the verification unit when the result of execution of Verify( ) at the step (c) is a value of false, a request for verification to an operation unit; (f) executing on-chain Verify( ) by the operation unit; and (g) imposing, by the operation unit when a result of verification of the proof is a value of false, a preset penalty from a deposit of the proof unit.

### Advantageous Effects

According to the present disclosure, provided is selective verification of zero-knowledge proofs (SVZK) wherein a proof value of a zero-knowledge proof is stored in the blockchain, but on-chain verification is performed only on a proof value for which the verification result is false. Therefore, compared to a method using the conventional zero-knowledge proofs, the cost of on-chain storage is reduced, and more transactions are stored in one block, improving scalability. In addition, users can use the same level of service at less cost than that of a verification method using the conventional zero-knowledge proofs.

According to the present disclosure, through the selective verification of zero-knowledge proofs (SVZK), various subjects are verified rather than just one subject at low cost, so that the present disclosure can be applied to an application for on-chain proof verification of NIZK, such as privacy-preserving transactions, proof of personal information without opening personal information (proof of an academic degree without opening school names). Therefore, verification using the system for SVZK is not limited to transactions and can be used in all situations where personal information is intended to be hidden using zero-knowledge proofs.

### DESCRIPTION OF DRAWINGS

FIG. 1 is a block diagram showing a selective verification system of zero-knowledge proofs for scalability of a blockchain according to an embodiment of the present disclosure.

FIG. 2 is a block diagram showing an overview of three types of work of a setup, proof, and a challenger in a selective verification system of zero-knowledge proofs for scalability of a blockchain according to an embodiment of the present disclosure.

FIG. 3 is a graph showing a result of an experiment with an increase in the number of if statements, in accordance with verification in a selective verification system of zero-knowledge proofs for scalability of a blockchain according to an embodiment of the present disclosure.

FIG. 4 is a graph showing a result of an experiment with a change only in private and public inputs of a Sudoku program given as an example in Zokrates, in accordance with verification in a selective verification system of zero-knowledge proofs for scalability of a blockchain according to an embodiment of the present disclosure.

FIG. 5 is a flowchart showing a process of registering and verifying a proof in a selective verification method of zero-knowledge proofs for scalability of a blockchain according to an embodiment of the present disclosure.

FIG. 6 is a flowchart showing a process of verifying a false proof in a selective verification method of zero-knowledge proofs for scalability of a blockchain according to an embodiment of the present disclosure.

### BEST MODE

Specific features and advantages of the present disclosure will be more clear from the following detailed description based on the accompanying drawings. The terms and words used in the present specification and claims should be interpreted as having meanings and concepts relevant to the technical scope of the present disclosure based on the rule wherein an inventor can appropriately define the concept of the term to describe most appropriately the best method he or she knows for carrying out the disclosure. In addition, it is noted that if a detailed description of known functions or configurations related to the present disclosure makes the subject matter of the present disclosure unclear, the detailed description is omitted.

According to an embodiment of the present disclosure, a zero-knowledge proof schematically includes a proving process of generating a proof and a verifying process of verifying the proof.

Herein, in the proving process, a proving key pk, w including a secret value, and a public input x are received to calculate and generate a proof. In the verifying process, a verifying key vk, the proof, and the public input x are received to determine whether the proof is true or false. Herein, a prover performs a function of executing proof, and a verifier performs a function of executing verification.

In addition, a smart contract stored in a blockchain serves as a verifier and is stored with the verifying key vk, and the proof is transmitted to the contract so that it is determined whether the proof is true or false from a result of execution.

Herein, costs of execution are incurred according to operation of the smart contract. Zero-knowledge proofs vary according to algorithms, but generally, proof verification requires an extremely costly fee.

Hereinafter, provided is a description of a configuration for improving scalability by reducing an operation fee charged for operation of a verification contract through selective verification of zero-knowledge proofs (SVZK) according to an embodiment of the present disclosure.

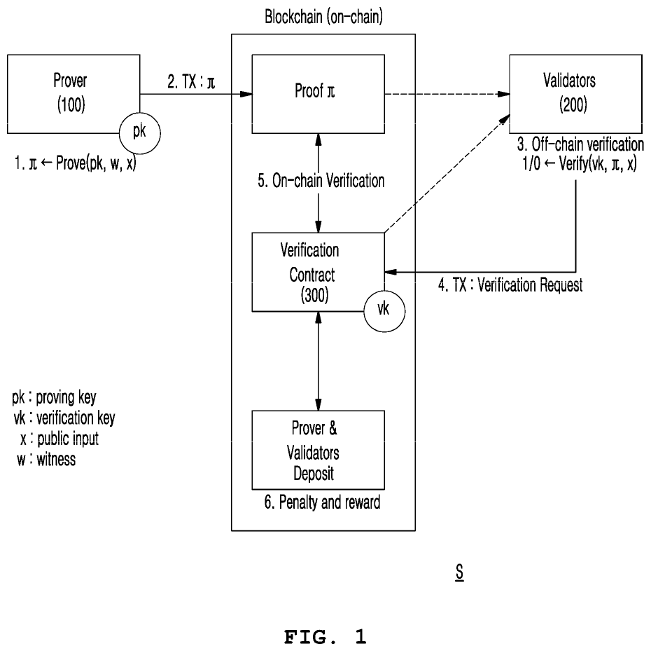

Referring to FIG. 1, according to an embodiment of the present disclosure, a selective verification system S of zero-knowledge proofs for scalability of a blockchain includes a prover (proof unit) 100, validators (verification unit) 200, and a verification contract (operation unit) 300.

First, the proof unit 100 generates a proof as a result of Prove( ) for the fact to be proved, generates a transaction in the blockchain, and stores the proof.

In addition, when a new proof is registered, the verification unit 200 executes off-chain Verify( ) for the contract, the vk, and the proof. When a result of execution is a value of true and a preset time elapses, the verification unit 200 determines that the proof is true. When the result of execution of Verify( ) is a value of false, the verification unit 200 transmits a request for verification to the operation unit 300.

In addition, the operation unit 300 executes on-chain Verify( ) in response to the request for verification from the verification unit 200, and when a result of execution of Verify( ) is a value of false, the operation unit 300 imposes a preset penalty from a deposit of the proof unit 100.

Herein, the operation unit 300 may repay a part of the imposed penalty to the verification unit 200 as a reward.

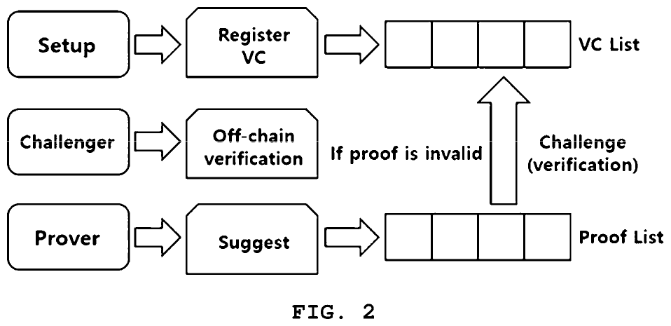

In the meantime, FIG. 2 is a block diagram showing an overview of three types of work of a setup, proof, and a challenger in a selective verification system S of zero-knowledge proofs for scalability of a blockchain according to an embodiment of the present disclosure.

As shown in FIG. 2, three types of users are provided: a setup user that wants to make a VC of the setup user available for users to have inexpensive verification, by using a system for SVZK; a prover that wants to prove a proof of the prover to the VC; and a challenger that wants to verify whether the proof of the prover is correct.

Setup

First, a setup is a process of setting a value to be proved in the system for SVZK. A verification contract for verifying a proof value is on-chain deployed and then is registered for SVZK. Through this work, the system is able to verify various proofs rather than only one proof, and the SVZK users register their on-chain deployed VCs so that proof values are confirmed at a low cost.

Register Verification Contract

In order to verify various verification values in the system for SVZK, a verification contract needs to be registered. To generate the VC, a program, such as Zokrates, for generating a VC may be used. In SVZK, an address of the VC uploaded to the blockchain is stored so that challengers are able to be aware of a contract for verifying a proof. The proof and the VC may be connected through the registered VC in the system for SVZK.

Prover—Suggest

In the SVZK according to an embodiment of the present disclosure, the prover uploads a proof value of the prover to an SVZK storage and when a predetermined period (epoch) elapses without any challenge received, the proof value is confirmed without executing on-chain verification. To this end, the prover matches a proof value to be proved and a VC for verifying the proof value and stores a result.

In addition, the prover may upload a false proof value, so in order to impose a penalty for this situation, a predetermined amount is deposited. Since a proof value needs to be confirmed when a predetermined period elapses in a block where the proof value is provided, a block number of the block is stored.

Challenger—Off-chain Computation

The challenger may execute off-chain verification of proof values uploaded to a proof list. When a result of off-chain verification of the proof value uploaded to the proof list is a value of false, on-chain verification is executed and it is found that the proof value is wrong.

In addition, there is cost of on-chain verification of the proof, but there is no cost of off-chain verification of the proof. Therefore, the proof in which a result of off-chain verification is a value of true is consequently confirmed when an epoch elapses, so on-chain verification does not need to be executed. However, the challenge may be executed to show that the proof in which the result is a value of false is a wrong proof.

Challenge

When a result of on-chain verification of a proof performed by a challenger is a value of false, the proof value is discarded and the challenger acquires the deposit of the prover that uploads the proof value. However, when the result of verification is a value of true, the proof value is confirmed even though an epoch does not elapse and the deposit is returned to the prover. Even if a challenger makes an objection to the true proof value, the wrong challenge does not adversely affect the system because a confirmation time for the prover is made earlier and the challenger needs to pay the verification cost that the prover is supposed to pay.

Confirm

Since on-chain verification of the proof value of the prover is costly, a verification period of a predetermined period is set and the proof value not reported by others during the period is confirmed as a correct proof value. Among the proof values in the proof list, isConfirm values of the proofs when a result of verification performed by the challenger is a value of true and when a predetermined block or more passes after the proof is generated are changed to be true, thereby confirming the proof values.

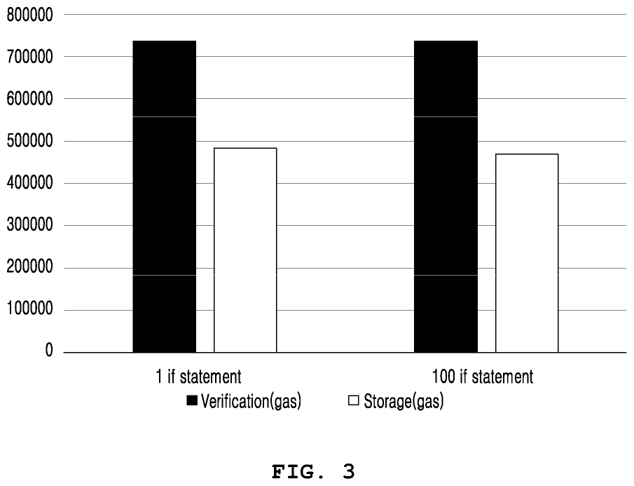

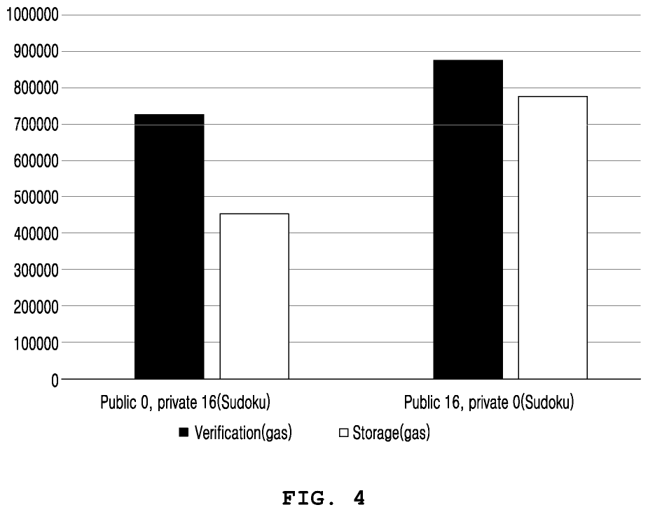

Hereinafter, with reference to FIGS. 3 and 4, results of experiments on a selective verification system S of zero-knowledge proofs for scalability of a blockchain according to an embodiment of the present disclosure will be described as follows.

An external smart contract or program may employ an inexpensive zero-knowledge proof using SVZK. Herein, a user may want to verify whether the proof value is confirmed. When a predetermined period elapses in a block after a proof is generated or when a proof value is confirmed, a value of true is returned. When no confirmation is obtained, a value of false is returned. As a result of an experiment with direct deployment of a VC, constraints were not related to the number of public values and private values and were added only when calculations were added.

FIG. 3 is a graph showing a result of an experiment with an increase in the number of if statements. As shown in FIG. 3, it was found that even though there was an increase in if statement and constraint, the cost of on-chain verification did not increase.

In the meantime, FIG. 4 is a graph showing a result of an experiment with a change only in private and public inputs of a Sudoku program given as an example in Zokrates.

When the number of public values increased, the cost of verification increased. Herein, the conventional verification method handles public values only in a memory, so despite the increase in public values, the influence is smaller than in the SVZK method in which public values are stored in a storage.

However, when the public values are less, the cost of verification is higher than the cost of storage. Therefore, the cost of SVZK was reduced by a fee of about 275,727 for one transaction than that of the conventional zero-knowledge proof verification method, and as a result, the scalability for a transaction verifying the zero-knowledge proof increased 1.6 times.

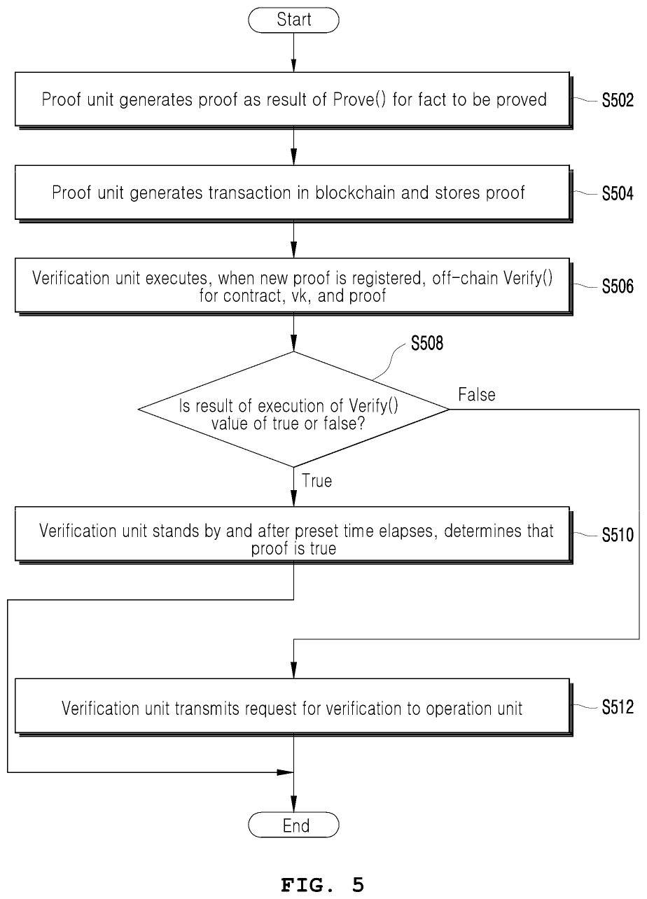

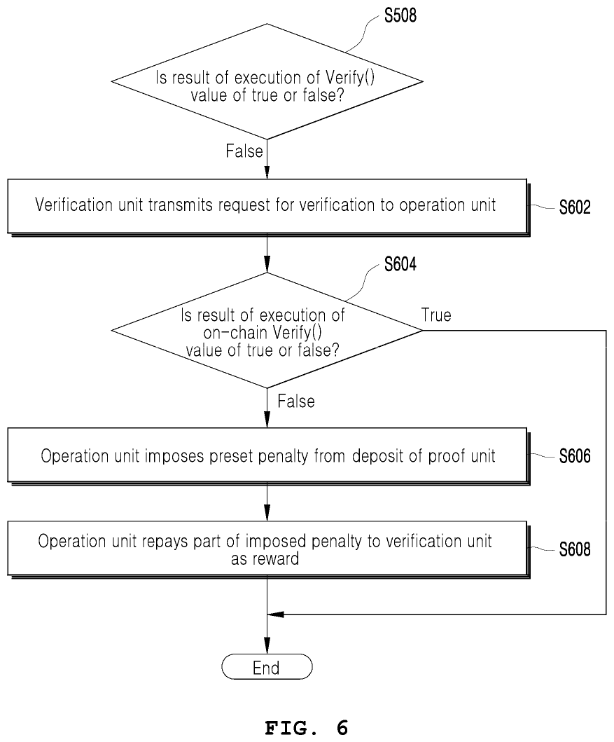

In the meantime, a selective verification method of zero-knowledge proofs for scalability of a blockchain according to an embodiment of the present disclosure includes a process of registering and verifying a proof, and a process of verifying a false proof. This will be described with reference to FIGS. 5 and 6 as follow.

1. Registration and Verification of Proof (FIG. 5)

First, the proof unit 100 generates a proof as a result of Prove( ) for the fact to be proved at step S502.

Next, the proof unit 100 generates a transaction in the blockchain and stores the proof at step S504.

Then, when a new proof is registered, the verification unit 200 executes off-chain Verify( ) for the contract, the vk, and the proof at step S506.

Next, the verification unit 200 determines whether a result of execution of Verify( ) is a value of true or false at step S508.

As a result of determination at step S508, when the result of execution of Verify( ) is a value of true and a preset time elapses, the verification unit 200 determines that the proof is true at step S510.

Conversely, as the result of determination at step S508, when the result of execution of Verify( ) is a value of false, the verification unit 200 transmits a request for verification to the operation unit 300 at step S512.

2. Verification of False Proof (FIG. 6)

As the result of determination at step S508, when the result of execution of Verify( ) is a value of false, the verification unit 200 transmits the request for verification to the operation unit 300 at step S602.

Next, in response to the request for verification from the verification unit 200 to the operation unit 300, the operation unit 300 executes on-chain Verify( ) at step S604.

Conversely, as a result of execution at step S604, when a result of verification of the proof is a value of false, the operation unit 300 imposes a preset penalty from the deposit of the proof unit 100 at step S606.

Next, the operation unit 300 repays a part of the imposed penalty to the verification unit 200 as a reward at step S608.

According to the selective verification system and method of the zero-knowledge proofs for scalability of the blockchain according to the embodiments of the present disclosure described above, regarding the cost charged in selective verification of zero-knowledge proofs (SVZK), all proofs are not verified in the blockchain, but only false proofs are verified in the blockchain, thereby reducing the cost of proving.

That is, all proofs and a predetermined deposit are stored in the blockchain, but the proof that is true as a result of off-chain verification executed by a user participating in the blockchain is not verified in the blockchain, the proof not verified in the blockchain for a preset period is confirmed as being true, and the deposit is returned.

In addition, when a result of off-chain verification of the proof is false, the proof is verified in the blockchain to confirm that the proof is false. In this process, because the verifier verifying that the proof is false executes a calculation of off-chain verification of the proof not sure whether it is true or false, the verifier proving that the proof is false in the blockchain is repaid the deposit of the user that stores the proof.

However, when the proof verified in the blockchain is true, the deposit is returned to an account of the user that stores the proof and the verifier pays the cost of the fee used for verification in the blockchain.

Although the technical idea of the present disclosure has been described in connection with the exemplary embodiments illustrated in the drawings, they are merely illustrative embodiments, and the disclosure is not limited to these embodiments. It is to be understood by those skilled in the art that various changes and modifications can be made without departing from the spirit and scope of the present disclosure. Therefore, all these changes, modifications, and equivalents should be regarded as falling within the scope of the present disclosure.

### DESCRIPTION OF THE REFERENCE NUMERALS IN THE DRAWINGS

S: Selective verification system of zero-knowledge proofs for scalability of blockchain
100: Proof unit
200: Verification unit
300: Operation unit

1. A selective verification system of zero-knowledge proofs for scalability of a blockchain, the system comprising:
a proof unit generating a proof as a result of Prove( ) for a fact to be proved, and generating a transaction in the blockchain and storing the proof;
a verification unit executing, when a new proof is registered, off-chain Verify( ) for a contract, a vk, and the proof, and when a result of execution is a value of true and a preset time elapses, determining that the proof is true; and
an operation unit executing on-chain Verify( ) in response to a request for verification from the verification unit.

2. The selective verification system of claim 1, wherein when the result of execution of off-chain Verify( ) is a value of false, the verification unit transmits the request for verification of the proof to the operation unit.

3. The selective verification system of claim 1, wherein when a result of execution of on-chain Verify( ) is a value of false, the operation unit imposes a preset penalty from a deposit of the proof unit.

4. A selective verification method of zero-knowledge proofs for scalability of a blockchain, the method comprising:
(a) generating, by a proof unit, a proof as a result of Prove( ) for a fact to be proved;
(b) generating, by the proof unit, a transaction in the blockchain and storing the proof;
(c) executing, by a verification unit, when a new proof is registered, off-chain Verify( ) for a contract, a vk, and the proof; and
(d) determining that the proof is true, by the verification unit, when a result of execution of Verify( ) at the step (c) is a value of true and a preset time elapses.

5. The selective verification method of claim 4, further comprising:
(e) transmitting, by the verification unit, when the result of execution of off-chain Verify( ) at the step (c) is a value of false, a request for verification to an operation unit;
(f) executing, by the operation unit, on-chain Verify( ) in response to the request for verification from the verification unit; and
(g) imposing, by the operation unit, when a result of verification of the proof is a value of false, a preset penalty from a deposit of the proof unit.
